(19) United States
(12) Patent Application Publication
(10) Pub. No.: US 2015/0370470 A1
(43) Pub. Date: Dec. 24, 2015

(54) METHOD AND APPARATUS FOR ADJUSTING POSITION IN STATUS BAR

(71) Applicant: TENCENT TECHNOLOGY (SHENZHEN) COMPANY LIMITED, Shenzhen (CN)

(72) Inventor: Jing Liu, Shenzhen (CN)

(73) Assignee: TENCENT TECHNOLOGY (SHENZHEN) COMPANY LIMITED, Shenzhen (CN)

(21) Appl. No.: 14/839,259

(22) Filed: Aug. 28, 2015

Related U.S. Application Data
(63) Continuation of application No. PCT/CN2014/071959, filed on Feb. 11, 2014.

(30) Foreign Application Priority Data
Apr. 28, 2013 (CN) 201310155612.3

(51) Int. Cl. G06F 3/0484; G06F 3/0485; G06F 3/0488

(52) U.S. Cl. CPC G06F 3/04847; G06F 3/04886; G06F 3/04883; G06F 3/04855; G06F 2203/04805; G06F 2203/04806

(57) ABSTRACT

A method and apparatus for adjusting the position in a status bar, the method including: obtaining a first operation instruction on a first position indicator on a first status bar; displaying a second status bar and a corresponding second position indicator in response to the first operation instruction; obtaining a second operation instruction on the second position indicator; adjusting the second position indictor on the second status bar to a second position in accordance with the second operation instruction; and adjusting a first position of the first position indicator on the first status bar in accordance with the second position.

### CROSS-REFERENCE TO RELATED APPLICATIONS

This application is a continuation of International Patent Application No. PCT/CN2014/071959, entitled “Method and Apparatus for Adjusting a Position in a Status Bar,” filed on Feb. 11, 2014. This application claims the benefit and priority of Chinese Patent Application No. 201310155612.3, entitled “Method and Apparatus for Adjusting a Position in a Status Bar” filed on Apr. 28, 2013. The entire disclosures of the above application are incorporated herein by reference.

### TECHNICAL FIELD

The present invention relates to computer technologies, and more particularly, to a method and apparatus for adjusting a position in a status bar.

### BACKGROUND

On electronic devices with a touch screen, the user can control the position in the status bar using his/her figures, such as the status bar in an audio or video player, or the status bar in the volume control.

The length of the status bar on the electronic device is often limited, yet the status bar with limited length often represents a prolong time period or a wide range of volume.

When a user adjusts the status bar using his/her figures, a slight sliding of the fingers only results in a significant change of the position in the status bar. To accurately adjust the position in the status bar, i.e., to adjust the position for a small increment, the sliding of the figures must be sufficiently small, which is often hard to achieve.

### SUMMARY OF THE INVENTION

Embodiments of the present invention provide a method and apparatus for accurately adjusting the position in a status bar.

In accordance with embodiments of the present invention, a method for adjusting the position in a status bar is provided, the method comprising: obtaining a first operation instruction on a first position indicator on a first status bar; displaying a second status bar and a corresponding second position indicator in response to the first operation instruction; obtaining a second operation instruction on the second position indicator; adjusting the second position indictor on the second status bar to a second position in accordance with the second operation instruction; and adjusting a first position of the first position indicator on the first status bar in accordance with the second position.

In accordance with embodiments of the present invention, an apparatus for adjusting the position in a status bar is provided, comprising: an operation instruction acquisition module configured to obtain a first operation instruction on a first position indicator on a first status bar; a display module configured to display a second status bar and a corresponding second position indicator in response to the first operation instruction, wherein the operation instruction acquisition module is further configured to obtain a second operation instruction on the second position indicator; and an adjustment module configured to adjust the second position indictor on the second status bar to a second position in accordance with the second operation instruction; and adjust a first position of the first position indicator on the first status bar in accordance with the second position.

In the embodiments of the present invention, a second status bar and a corresponding second position indicator associated with a first status bar and a first position indicator are displayed, and a first position corresponding to the first position indicator is controlled through a second position corresponding to the second position indicator, which makes it easier to accurately adjust the first position.

### BRIEF DESCRIPTION OF THE DRAWINGS

To better illustrate the technical features of the embodiments of the present invention, various embodiments of the present invention will be briefly described in conjunction with the accompanying drawings. It is obvious that the draws are but for exemplary embodiments of the present invention, and that a person of ordinary skill in the art may derive additional draws without deviating from the principles of the present invention.

FIG. 1 is an exemplary schematic diagram for a computer or electronic device for implementing the method and apparatus for adjusting a position in a status bar in accordance with embodiments of the present invention.

FIG. 2 is an exemplary schematic diagram for an apparatus for adjusting a position in a status bar in accordance with an embodiment of the present invention.

FIG. 3 is an exemplary schematic diagram for an apparatus for adjusting a position in a status bar in accordance with another embodiment of the present invention.

FIG. 4 is an exemplary schematic diagram for an apparatus for adjusting a position in a status bar in accordance with yet another embodiment of the present invention.

FIG. 5 is an exemplary schematic diagram of adjusting a position in a status bar in accordance with an embodiment of the present invention.

FIG. 6 is an exemplary flowchart for a method for adjusting a position in a status bar in accordance with an embodiment of the present invention.

FIG. 7 is an exemplary flowchart for a method for adjusting a position in a status bar in accordance with another embodiment of the present invention.

FIG. 8 is an exemplary flowchart for a method for adjusting a position in a status bar in accordance with yet another embodiment of the present invention.

FIG. 9 is an exemplary flowchart for a method for adjusting a position in a status bar in accordance with yet another embodiment of the present invention.

### DESCRIPTION OF THE PREFERRED EMBODIMENTS

To better illustrate the purpose, technical feature, and advantages of the embodiments of the present invention, various embodiments of the present invention will be further described in conjunction with the accompanying drawings.

FIG. 1 is an exemplary schematic diagram for a computer or electronic device for implementing the method and apparatus for adjusting a position in a status bar in accordance with embodiments of the present invention. As shown in FIG. 1, the method and apparatus for adjusting a position in a status bar in accordance with embodiments of the present invention can be implemented in a computer or an electronic device with an operating system for portable mobile devices. The computer can be a personal computer (PC) or a server; and the electronic device can be a mobile terminal, a pocket computer, or a tablet computer. In particular, the computer or the electronic device has a touch screen allowing the user to operate the computer or the electronic device. When the user uses a software application on the computer or the electronic device, such as a media player, the user can interact with the software application through the touch screen. The computer or the electronic device 100 can include a processor 101, a storage unit 102, a power supply 103, a switch 104, a sensor 105, a timer 106, and an input/out device 107, and a touch screen (not shown in FIG. 1), or any combination of the above. The computer or the electronic device 100 can be used to implement the method and apparatus for adjusting a position in a status bar in accordance with embodiments of the present invention. Specifically, program instructions for implementing the method and apparatus can be stored in the storage unit 102, executed by the processor 101, and interact with the user through the touch screen.

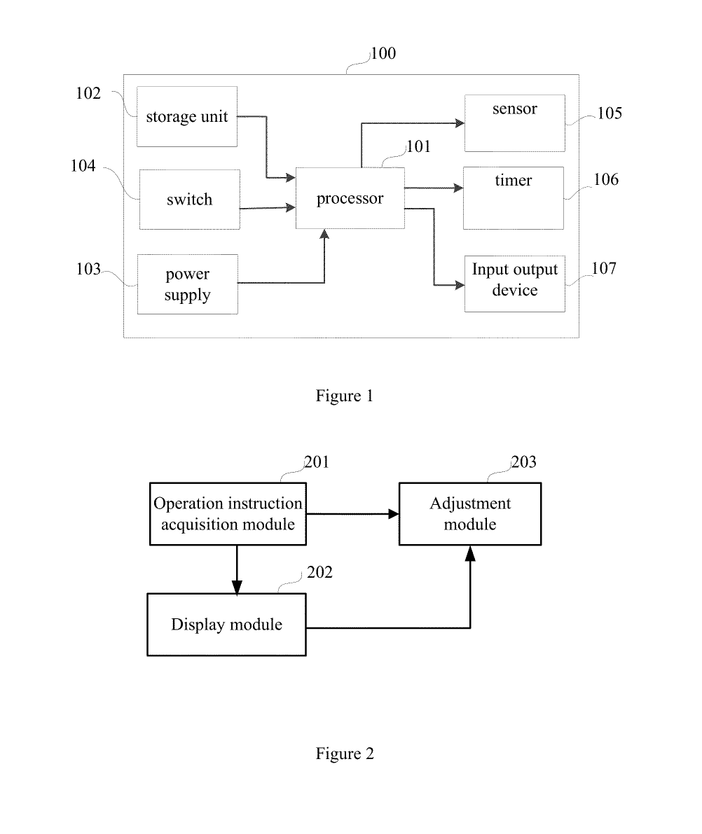

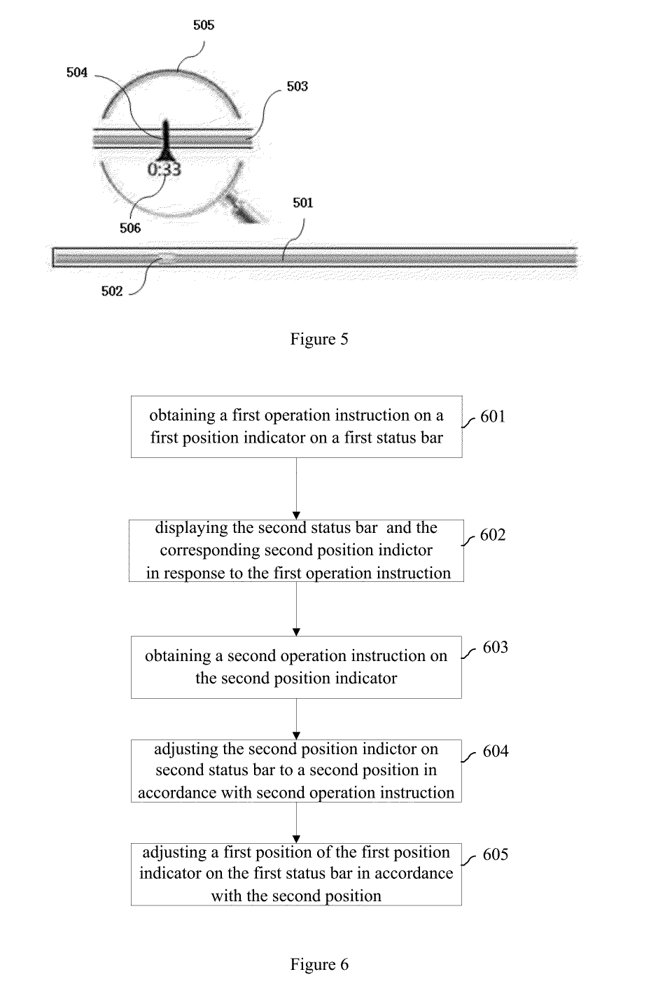

FIG. 2 is an exemplary schematic diagram for an apparatus for adjusting a position in a status bar in accordance with an embodiment of the present invention. FIG. 5 is an exemplary schematic diagram of adjusting a position in a status bar in accordance with an embodiment of the present invention.

As shown in FIG. 2, the apparatus for adjusting a position in a status bar in this embodiment includes an operation instruction acquisition module 201, a display module 202, and an adjustment module 203.

The operation instruction acquisition module 201 is configured to obtain a first operation instruction on a first position indicator 502 on a first status bar 501. The first operation instruction can be the operation instruction generated when a user presses the first position indictor 502. The operation instruction acquisition module 201 can obtain the first operation instruction from the user through a touch screen of a computer or an electronic device, and the first operation instruction corresponds to the user operation on the first position indicator 502. The first status bar 501 and the first position indicator 502 can be generated in the user interface (UI) of software applications on the computer or the electronic device. The first operation instruction can be viewed as an interactive action between the user and the software applications on the computer or the electronic device.

The display module 202 is configured to display a second status bar 503 and a corresponding second position indicator 504 in response to the first operation instruction. The second status bar 503 and the second position indicator 504 do not overlap with the first status bar 501 and the first position indicator 502. Specifically, the second status bar 503 and the second position indicator 504 can be located either above or below (or on the left or right of) the first status bar 501 and the first position indicator 502. The display module 202 can be viewed as hardware combination of the display screen and the video processor. The second status bar 503 and the second position indicator 504 displayed by the display module 202 can be viewed as a response to the first operation instruction.

The operation instruction acquisition module 201 is also configured to obtain a second operation instruction on the second position indicator 504. The second operation instruction can be the operation instruction generated when a user presses the second position indictor 504.

The adjustment module 203 is configured to adjust the second position indictor 504 on the second status bar 503 to a second position in accordance with the second operation instruction; and adjust a first position of the first position indicator 502 on the first status bar 501 in accordance with the second position.

The second position of the second position indicator 502 is associated with the first position of the first position indicator 501. Here, the term “associated with” means that the first position and the second position have a linear relationship, i.e., when the second position increases by a particular percentage, the first position increases by a particular percentage as well; and when the second position decreases by a particular percentage, the first position decreases by a particular percentage as well.

In this embodiment, a second status bar 503 and a corresponding second position indicator 504 associated with a first status bar 501 and a first position indicator 502 are displayed, and a first position corresponding to the first position indicator 502 is controlled through a second position corresponding to the second position indicator 504, which makes it easier to accurately adjust the the first position.

In another embodiment, the display module 202 is further configured to generate a display area 505 in response to the first operation instruction; and display the second status bar 503 and the corresponding second position indictor 504 in the display area 505.

In this embodiment, a display area 505 is generated, and the second status bar 503 and the corresponding second position indicator 504 are displayed in the display area 505, which ensures that the second status bar 503 and the second position indicator 504 do not overlap with the first status bar 501 and the first position indicator 502.

In another embodiment, the display area 505 corresponds to an enlarged area comprising the first position indictor 502. As shown in FIG. 5, the enlarged area can include the first position indictor 502 and a region in the first status bar 501 surrounding the first position indicator 502.

In this embodiment, the area surrounding the first position indicator 502 is enlarged and displayed, which provides the user with a more detailed image to facilitate accurate adjustment of the position in the status bar. In another words, the user can operate in the enlarged area to accurately adjust the position in the status bar.

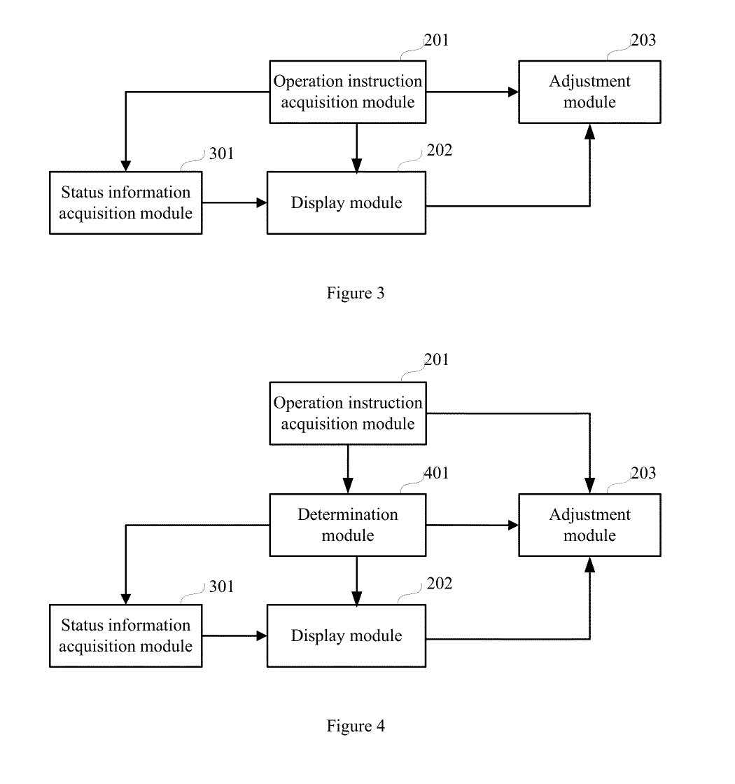

FIG. 3 is an exemplary schematic diagram for an apparatus for adjusting a position in a status bar in accordance with another embodiment of the present invention. As shown in FIG. 3, this embodiment is similar to the embodiment above, but the apparatus further includes a status information acquisition module 301.

The status information acquisition module 301 is configured to obtain status information 506 corresponding to the first position indictor 502 in response to the first operation instruction, and the display module 202 is further configured to display the status information 506 in the display area 505.

In this embodiment, the status information 506 corresponding to the first position indictor 502 is obtained, and then displayed in the display area 505, which provides the user with detailed information regarding the status bar to facilitate 4 accurate adjustment of the position in the status bar.

FIG. 4 is an exemplary schematic diagram for an apparatus for adjusting a position in a status bar in accordance with yet another embodiment of the present invention. As shown in FIG. 4, the apparatus further include a determination module 401.

The determination module 401 is configured to determine whether an operation duration on the first position indictor 502 is greater than a present time, and the display module 202 is further configured to display the second status bar 503 and the corresponding second position indictor 504 after determining that the operation duration time is greater than the preset time.

In this embodiment, whether an operation duration on the first position indictor 502 is greater than a present time is determined, and the second status bar 503 and the corresponding second position indictor 504 is displayed only if it is determined that the operation duration time is greater than the preset time, which can be used to identify the users' operation to accurately adjust the status bar. The second status bar 503 and the corresponding second position indictor 504 are displayed only if the user desires to accurately adjust the status bar, which ensures that the relevant operation will be performed only when needed.

FIG. 6 is an exemplary flowchart for a method for adjusting a position in a status bar in accordance with an embodiment of the present invention. As shown in FIG. 6, this embodiment is similar to the embodiment above, but the method for adjusting a position in a status bar in this embodiment further includes the following steps.

Step 601: the operation instruction acquisition module 201 obtaining a first operation instruction on a first position indicator 502 on a first status bar 501. The first operation instruction can be the operation instruction generated when a user presses the first position indictor 502. The operation instruction acquisition module 201 can obtain the first operation instruction from the user through a touch screen of a computer or a electronic device, and the first operation instruction corresponds to the user operation on the first position indicator 502. The first status bar 501 and the first position indicator 502 can be generated in the user interface (UI) of software applications on the computer or the electronic device. The first operation instruction can be viewed as an interactive action between the user and the software applications on the computer or the electronic device.

Step 602: the display module 202 displaying a second status bar 503 and a corresponding second position indicator 504 in response to the first operation instruction. The second status bar 503 and the second position indicator 504 do not overlap with the first status bar 501 and the first position indicator 502. Specifically, the second status bar 503 and the second position indicator 504 can be located either above or below (or on the left or right of) the first status bar 501 and the first position indicator 502. The display module 202 can be viewed as hardware combination of the display screen and the video processor. The second status bar 503 and the second position indicator 504 displayed by the display module 202 can be viewed as a response to the first operation instruction.

Step 603: the operation instruction acquisition module 201 obtaining a second operation instruction on the second position indicator 504. The second operation instruction can be the operation instruction generated when a user presses the second position indictor 504.

Step 604: the adjustment module 203 adjusting the second position indictor 504 on the second status bar 503 to a second position in accordance with the second operation instruction.

Step 605: the adjustment module 203 adjusting a first position of the first position indicator 502 on the first status bar 501 in accordance with the second position.

The second position of the second position indicator 502 is associated with the first position of the first position indicator 501. Here, the term “associated with” means that the first position and the second position have a linear relationship, i.e., when the second position increases by a particular percentage, the first position increases by a particular percentage as well; and when the second position decreases by a particular percentage, the first position decreases by a particular percentage as well.

In this embodiment, a second status bar 503 and a corresponding second position indicator 504 associated with a first status bar 501 and a first position indicator 502 are displayed, and a first position corresponding to the first position indicator 502 is controlled through a second position corresponding to the second position indicator 504, which makes it easier to accurately adjust the the first position.

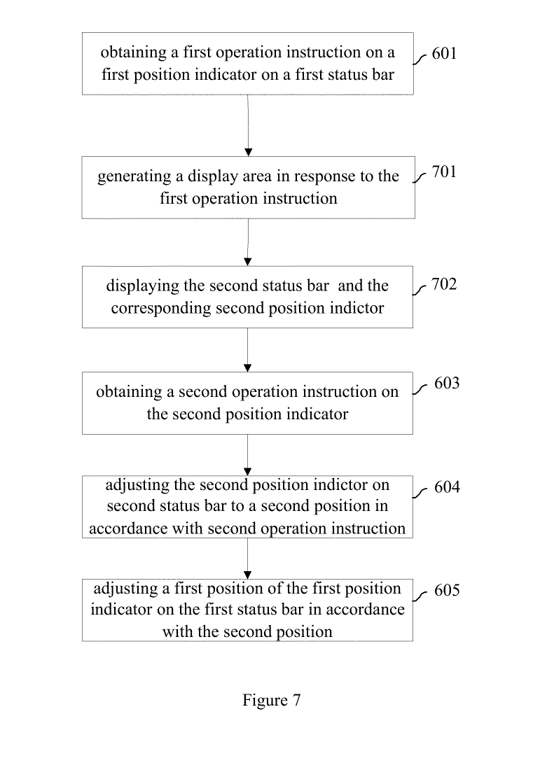

FIG. 7 is an exemplary flowchart for a method for adjusting a position in a status bar in accordance with another embodiment of the present invention. This embodiment is similar to the embodiment above, but the step of the display module 202 displaying a second status bar 503 and a corresponding second position indicator 504 in response to the first operation instruction (Step 602) further includes the following steps:

Step 701: the display module 202 generating a display area 504 in response to the first operation instruction.

Step 702: the display module 202 displaying the second status bar 503 and the corresponding second position indictor 504 in the display area 505.

In this embodiment, a display area 505 is generated, and the second status bar 503 and the corresponding second position indicator 504 are displayed in the display area 505, which ensures that the second status bar 503 and the second position indicator 504 do not overlap with the first status bar 501 and the first position indicator 502.

In another embodiment, the display area 505 corresponds to an enlarged area comprising the first position indictor 502. As shown in FIG. 5, the enlarged area can include the first position indictor 502 and a region in the first status bar 501 surrounding the first position indicator 502.

In this embodiment, the area surrounding the first position indicator 502 is enlarged and displayed, which provides the user with a more detailed image to facilitate accurate adjustment of the position in the status bar. In another words, the user can operate in the enlarged area to accurately adjust the position in the status bar.

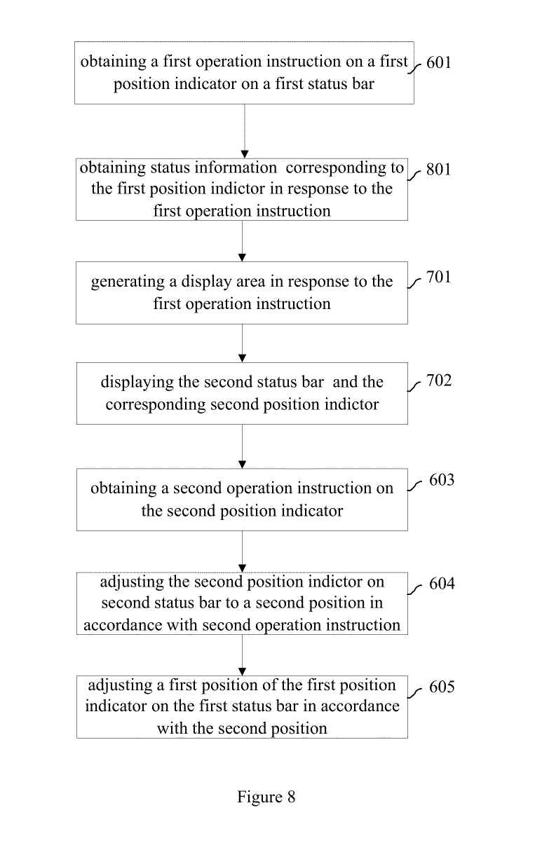

FIG. 8 is an exemplary flowchart for a method for adjusting a position in a status bar in accordance with yet another embodiment of the present invention. As shown in FIG. 8, this embodiment is similar to the embodiments above, but after the step of the operation instruction acquisition module 201 obtaining a first operation instruction on a first position indicator 502 on a first status bar 501 (Step 601), the method further includes Step 801.

Step 801: the status information acquisition module 301 obtaining status information 506 corresponding to the first position indictor 502 in response to the first operation instruction.

Step 702 also includes the display module 202 displaying the status information 506 in the display area 505.

In this embodiment, the status information 506 corresponding to the first position indictor 502 is obtained, and displayed in the display area 505, which provides the user with detailed information regarding the status bar to facilitate 4 accurate adjustment of the position in the status bar.

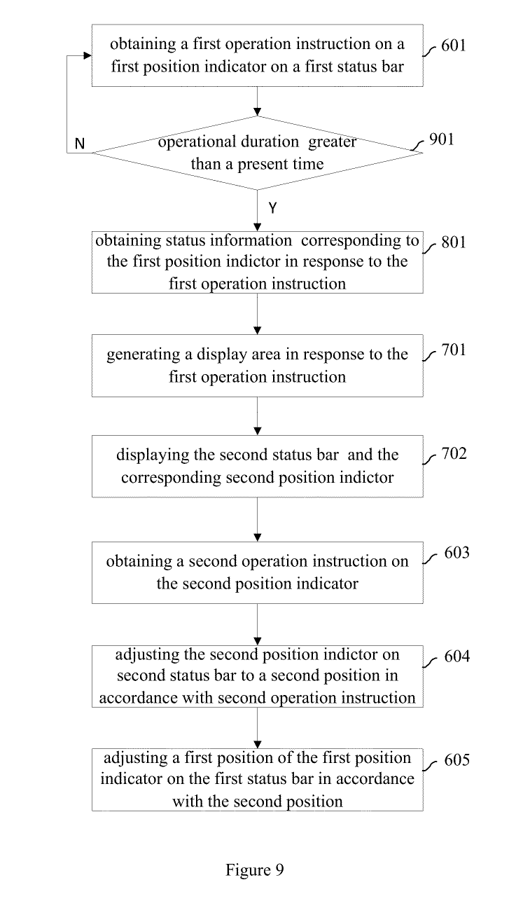

FIG. 9 is an exemplary flowchart for a method for adjusting a position in a status bar in accordance with yet another embodiment of the present invention. As shown in FIG. 9, this embodiment is similar to the embodiments above, but after the step of the operation instruction acquisition module 201 obtaining a first operation instruction on a first position indicator 502 on a first status bar 501 (Step 601) and prior to step of the display module 202 displaying a second status bar 503 and a corresponding second position indicator 504 in response to the first operation instruction (Step 602), the method further includes Step 901.

Step 901: the determination module 401 determining whether an operational duration on the first position indictor 502 is greater than a present time.

The step of the display module 202 displaying the second status bar 503 and the corresponding second position indictor 504 in response to the first operation instruction (Step 702) also includes the display module 202 displaying the second status bar 503 and the corresponding second position indictor 504 after determining that the operation duration time is greater than the preset time.

In this embodiment, whether an operation duration on the first position indictor 502 is greater than a present time is determined, and the second status bar 503 and the corresponding second position indictor 504 is displayed only if it is determined that the operation duration time is greater than the preset time, which can be used to identify the users' operation to accurately adjust the status bar. The second status bar 503 and the corresponding second position indictor 504 are displayed only if the user desires to accurately adjust the status bar, which ensures that the relevant operation will be performed only when needed.

The various modules, units, and components described above can be implemented as an Application Specific Integrated Circuit (ASIC); an electronic circuit; a combinational logic circuit; a field programmable gate array (FPGA); a processor (shared, dedicated, or group) that executes code; or other suitable hardware components that provide the described functionality. The processor can be a microprocessor provided by from Intel, or a mainframe computer provided by IBM.

Note that one or more of the functions described above can be performed by software or firmware stored in memory and executed by a processor, or stored in program storage and executed by a processor. The software or firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The various embodiments of the present invention are merely preferred embodiments, and are not intended to limit the scope of the present invention, which includes any modification, equivalent, or improvement that does not depart from the spirit and principles of the present invention.

1. A method for adjusting the position in a status bar, the method comprising:
obtaining a first operation instruction on a first position indicator on a first status bar;
displaying a second status bar and a corresponding second position indicator in response to the first operation instruction;
obtaining a second operation instruction on the second position indicator;
adjusting the second position indictor on the second status bar to a second position in accordance with the second operation instruction; and
adjusting a first position of the first position indicator on the first status bar in accordance with the second position.

2. The method of claim 1, wherein the step of displaying a second status bar and a corresponding second position indicator in response to the first operation instruction comprises:
generating a display area in response to the first operation instruction; and
displaying the second status bar and the corresponding second position indictor in the display area.

3. The method of claim 2, wherein the display area corresponds to an enlarged area comprising the first position indictor.

4. The method of claim 3, further comprising, after the step of obtaining a first operation instruction on a first position indicator on a first status bar:
obtaining status information corresponding to the first position indictor in response to the first operation instruction; and
displaying the status information in the display area.

5. The method of claim 4, further comprising:
determining whether an operation duration on the first position indictor is greater than a present time; and
displaying the second status bar and the corresponding second position indictor after determining that the operation duration time is greater than the preset time.

6. An apparatus for adjusting the position in a status bar, comprising:
an operation instruction acquisition module configured to obtain a first operation instruction on a first position indicator on a first status bar;
a display module configured to display a second status bar and a corresponding second position indicator in response to the first operation instruction, wherein the operation instruction acquisition module is further configured to obtain a second operation instruction on the second position indicator; and
an adjustment module configured to adjust the second position indictor on the second status bar to a second position in accordance with the second operation instruction; and adjust a first position of the first position indicator on the first status bar in accordance with the second position.

7. The apparatus of claim 6, wherein the display module is further configured to:
generate a display area in response to the first operation instruction; and
display the second status bar and the corresponding second position indictor in the display area.

8. The apparatus of claim 7, wherein the display area corresponds to an enlarged area comprising the first position indictor.

9. The apparatus of claim 8, further comprising:
a status information acquisition module configured to obtain status information corresponding to the first position indictor in response to the first operation instruction; wherein
the display module is further configured to display the status information in the display area.

10. The apparatus of claim 9, further comprising:
a determination module configured to determine whether an operation duration on the first position indictor is greater than a present time; and wherein
the display module is further configured to display the second status bar and the corresponding second position indictor after determining that the operation duration time is greater than the preset time.

11. A method for displaying a status bar, the method comprising:
obtaining a first operation instruction on a first position indicator on a first status bar; and
displaying a second status bar and a corresponding second position indicator in response to the first operation instruction;
wherein the second status bar represents an enlarged first status bar, and the second position indicator represents an enlarged first position indictor.

12. The method of claim 11, further comprising:
obtaining status information corresponding to the first position indictor in response to the first operation instruction; and
displaying the status information.

13. The method of claim 11, wherein the first operation instruction is generated in response to an operation on the first position indicator on the first status bar over a preset time.

14. The method of claim 13, wherein the operation comprises pressing the first position indicator on the first status bar on a touch screen.

15. The method of claim 11, further comprising:
adjusting the first position indicator on the first status bar in response to an adjustment to the second position indicator on the second status bar.

16. An apparatus for displaying a status bar, comprising:
an operation instruction acquisition module configured to obtain a first operation instruction on a first position indicator on a first status bar; and
a display module configured to display a second status bar and a corresponding second position indicator in response to the first operation instruction;
wherein the second status bar represents an enlarged first status bar, and the second position indicator represents an enlarged first position indictor.

17. The apparatus of claim 16, further comprising:
a status information acquisition module configured to obtain status information corresponding to the first position indictor in response to the first operation instruction; and
wherein the display module is further configured to display the status information.

18. The apparatus of claim 16, wherein the first operation instruction is generated in response to an operation on the first position indicator on the first status bar over a preset time.

19. The method of claim 18, wherein the operation comprises pressing the first position indicator on the first status bar on a touch screen.

20. The apparatus of claim 16, further comprising:
an adjustment module configured to adjust the first position indicator on the first status bar in response to an adjustment to the second position indicator on the second status bar.
